(19) United States
(12) Patent Application Publication
(10) Pub. No.: US 2013/0140389 A1
(43) Pub. Date: Jun. 6, 2013

(54) SEAT BELT RETRACTOR COMPRISING A TENSIONING DRIVE

(71) Applicant: TAKATA AG, Aschaffenburg (DE)

(72) Inventors: Christoph Pechhold, Erbach (DE); Gerhard Klingauf, Balzheim (DE); Robert Fleischmann, Neu-Ulm / Pfuhl (DE); Carsten Felber, Jettingen-Schepach (DE); Heinrich Einsiedel, Ulm (DE); Udo Friedsmann, Dornstadt (DE)

(73) Assignee: TAKATA AG, Aschaffenburg (DE)

(21) Appl. No.: 13/756,773

(22) Filed: Feb. 1, 2013

Related U.S. Application Data
(63) Continuation of application No. PCT/DE2011/050015, filed on May 25, 2011.

(30) Foreign Application Priority Data
Aug. 3, 2010 (DE) 10 2010 033 184.8

(51) Int. Cl. B60R 22/46

(52) U.S. Cl. CPC B60R 22/4628
USPC 242/374; 264/328.1

(57) ABSTRACT

A seat belt retractor for a safety belt is provided. The retractor includes a seat belt spindle for winding up and unwinding the safety belt and a tensioning drive, which comprises a gas generator, a drive wheel and a supply pipe which connects the gas generator and the drive wheel, a plurality of thrust elements being present in the supply pipe which, after triggering the gas generator, are accelerated and indirectly or directly drive the drive wheel for winding up the safety belt. At least one of the thrust elements is a fiber-reinforced thrust element.

### CROSS-REFERENCE TO RELATED PATENT APPLICATIONS

This application is a continuation of International Patent Application Number PCT/DE2011/050015, filed on May 25, 2011, which was published in German as WO 2012/016567. The foregoing international application is incorporated by reference herein.

### BACKGROUND

Such a seat belt retractor comprising a tensioning drive is known from European patent application EP 1 283 137. The tensioning drive comprises a gas generator, a drive wheel and a connecting device which connects the gas generator and the drive wheel. The connecting device comprises a supply pipe and a multiplicity of thrust elements or thrust members located in the supply pipe, which are accelerated after triggering the gas generator and drive the drive wheel for winding up the safety belt. In the case of the previously known seat belt retractor, the thrust elements consist of metal.

### SUMMARY

Proceeding from the described prior art, an object of the invention is to provide a seat belt retractor which exhibits even better operating behavior.

A seat belt retractor for a safety belt includes a seat belt spindle for winding up and unwinding the safety belt and a tensioning drive. The retractor includes a gas generator, a drive wheel and a supply pipe which connects the gas generator and the drive wheel, a plurality of thrust elements being present in the supply pipe which, after triggering the gas generator, are accelerated and indirectly or directly drive the drive wheel for winding up the safety belt.

Accordingly, according to a disclosed embodiment of the invention, at least one of the thrust elements (or thrust members) is a fiber-reinforced thrust element.

A substantial advantage of the seat belt refractor according to an embodiment of the invention can be seen in the fact that, owing to the fiber reinforcement, the thrust elements have greater mechanical stability than thrust elements made from the same material (or a similar material) without fiber reinforcement. The risk of the thrust elements being destroyed during the tensioning operation is therefore reduced and an interference-free tensioning operation is even more reliable.

The fibers in the fiber-reinforced thrust element particularly preferably have a preferred orientation. By means of a suitable alignment of the preferred orientation, the risk of the thrust elements breaking can be reduced even further.

The fiber-reinforced thrust element is preferably guided in the supply pipe in such a manner that the alignment of said thrust element and therefore the alignment of the fibers remain the same—with respect to the particular direction of movement—during the movement through the supply pipe. Such an alignment-maintaining guidance can be achieved by a “guiding” shaping of the internal cross section of the supply pipe (for example by means of guide grooves or an angular cross section) or by a fixed or loose chain formation of the thrust elements. The last-mentioned, preferred refinement will be discussed in more detail further below.

At least half of the fibers of the fiber-reinforced thrust element are particularly preferably at an angle of less than 45 degrees to a mean main fiber direction. The mean main fiber direction therefore forms a preferred orientation of the fibers in the fiber-reinforced thrust element.

It is considered to be advantageous if the fiber-reinforced thrust element is guided in the supply pipe in such a manner that the angle between the main fiber direction and the particular direction of movement is always smaller than 45 degrees. The effect which can be achieved in the case of this refinement is that the stability-increasing effect of the fibers is maintained even if the thrust elements are guided through curved sections of the supply pipe.

The angle between the main fiber direction and the particular direction of movement is preferably always smaller than 10 degrees (for example 0 degrees±5 degrees). The main fiber direction particularly preferably corresponds to the particular direction of movement.

The thrust elements may be, for example, in the shape of a drum and/or may be round, elliptical or angular in cross section. However, it is considered to be particularly advantageous if the fiber-reinforced thrust elements have an axis of symmetry. The angle between the axis of symmetry and the main fiber direction is preferably smaller than 10 degrees (for example 0 degrees±5 degrees), and the axis of symmetry and the main fiber direction particularly preferably rest one on the other. The symmetry of the thrust element may be, for example, rotational symmetry.

The fiber-reinforced thrust element is particularly preferably guided in the supply pipe in such a manner that the angle between the axis of symmetry and the particular direction of movement during the movement through the supply pipe is smaller than 45 degrees and particularly preferably smaller than 10 degrees (for example 0 degrees±5 degrees).

If the thrust elements are produced within the scope of a casting or injection molding process, it is considered to be advantageous if the injection is undertaken at an angle of between 0 degrees and 30 degrees—with respect to the longitudinal axis of the thrust element or with respect to the subsequent direction of movement of the thrust elements. In the case of such an injection angle, an automatic alignment of the longitudinal direction of the fibers of the cast material in the longitudinal direction of the thrust elements and therefore along the subsequent direction of movement of the thrust elements can be achieved in a particularly advantageous manner.

At least two consecutive thrust elements in the supply pipe are preferably partially plugged one into the other and form an (at least two-membered) thrust element chain. The thrust elements which are partially plugged one into the other are preferably plugged in loosely or releasably and form a releasable thrust element chain.

For the loose chain formation, at least one thrust element in the supply pipe preferably has at least one plug-in section which is plugged into a recess in an adjacent thrust element in the supply pipe. The plug-in section and the recess are preferably dimensioned in such a manner that the thrust elements which are plugged one into another can pivot relative to one another. This makes it possible to bend the forming thrust element chain and to push the latter through curved regions in the supply pipe. The effect which can be achieved by the combination of plug-in section and recess is that the alignment of the thrust elements relative to the particular direction of movement is maintained during the tensioning operation.

It is also considered to be advantageous if two or more thrust elements are connected fixedly to one another forming a twin group (pair or thrust elements), a triple group or a multi-membered thrust element chain.

In order to form a nonreleasable thrust element chain, the thrust elements are, for example, connected to one another, specifically preferably by means of one or more strand-shaped links.

According to a first particularly preferred variant embodiment, the thrust elements of the thrust element chain are connected to one another by webs. The webs are preferably already formed during the production of the thrust elements. The thrust element chain is preferably produced within the scope of an injection molding process, in which the thrust elements of the thrust element chain and the webs are cast together. The injection point or the injection points of the injection molding material containing the fibers or the injection point or the injection points of the injection molding material into the injection mold are preferably at least also located at the or in the region of the end of the thrust element chain. The injection is particularly preferably carried out at an angle of between 0 degrees and 30 degrees—with respect to the longitudinal axis of the thrust element chain or with respect to the subsequent direction of movement of the thrust elements. In the event of an injection point in the region of the chain end and/or by the selection of a corresponding injection angle, the injection molding material can be pressed in a particularly simple manner through the web regions of the injection mold, thus resulting in a particularly advantageous manner in automatic alignment of the longitudinal direction of the fibers of the injection molding material in the longitudinal direction of the chain and therefore along the subsequent direction of movement of the thrust elements because the fibers are automatically aligned as the latter pass the web regions.

According to a second particularly preferred variant embodiment, the thrust elements are connected to one another by a flexible, strand-shaped link, in particular a cable or a wire. The strand-shaped link is preferably guided through at least two thrust elements.

The strand-shaped link is particularly preferably embedded in the fiber-reinforced material of at least two thrust elements, in particular cast with the fiber-reinforced material of at least two thrust elements. It is also considered to be advantageous in this case if the injection is undertaken at an angle of between 0 degrees and 30 degrees—with respect to the longitudinal axis of the thrust element chain and with respect to the subsequent direction of movement of the thrust elements. In the event of such an injection angle, an automatic alignment of the longitudinal direction of the fibers of the injection molding material in the longitudinal direction of the chain and therefore along the subsequent direction of movement of the thrust elements can be achieved in a particularly advantageous manner.

In a particularly advantageous refinement, it is provided that at least one of the thrust elements consists of a fiber-reinforced, for example glass-fiber-reinforced, plastic or at least also contains such a material.

A substantial advantage of this particularly preferred refinement can be seen in the fact that said thrust element may have a lower weight than previously known seat belt retractors. This is because fiber-reinforced plastic is less dense than metal. When fiber-reinforced plastic is used, the weight reduction of the thrust element assembly may be up to 80%, compared with a thrust element assembly consisting of metal.

A further substantial advantage of this particularly preferred refinement can be seen in the fact that said thrust element also reliably functions even in the event of an external action of heat. This is because, in contrast to metal thrust elements, fiber-reinforced thrust elements have the advantageous property of less frequently jamming in the supply pipe even in the event of external heating than is the case for thrust elements consisting of metal. Jamming of the thrust elements may be based, for example, on deformation, melting and/or on an increase in volume of the thrust elements in the event of external heating; such a temperature-induced jamming of the thrust elements is less severe in the case of thrust elements made from fiber-reinforced plastic than in the case of metal thrust elements.

A third substantial advantage of this particularly preferred refinement resides in the lower production costs in comparison to conventional seat belt retractors, since fiber-reinforced plastic is significantly more cost-effective than metal.

A fourth substantial advantage of this particularly preferred refinement can be seen in the fact that the drive system according to an embodiment of the invention is more rapid than the corresponding drive systems in previously known seat belt retractors; this is because the inertia of thrust elements consisting of fiber-reinforced plastic is lower because of the lower density than the inertia of metal thrust elements.

A fifth substantial advantage of this particularly preferred refinement consists in that the noise produced during the operation is lower than in the case of seat belt retractors consisting of metal.

A sixth substantial advantage of this particularly preferred refinement can be seen in the fact that the receptacle in which the thrust elements are collected after triggering of the drive is subjected to a less severe load than is the case with thrust elements made of metal. This is because—as already mentioned—fiber-reinforced plastic has a lower density and therefore the mass which has to be collected by the collecting body is smaller than in the case of thrust elements made of metal.

All of the thrust elements preferably consist of fiber-reinforced plastic.

The fibers of the fiber-reinforced plastic are preferably (exclusively or at least also) glass fibers, but use may also be made of fibers of a different material, such as, for example, of ceramic or carbon (carbon fibers). The thrust element material can therefore be, for example, glass-fiber-reinforced plastic.

For the described use particularly suitable plastics materials are polyamide and polyphthalamide; accordingly, it is considered to be advantageous if the fiber-reinforced plastic at least also contains polyamide and/or polyphthalamide.

If polyamide is used, use is preferably made of a heat-stabilized, partially crystalline polyamide.

The fiber-reinforced plastic is particularly preferably reinforced with long fibers (for example long glass fibers). The fibers of the fiber-reinforced plastic preferably have a length of at least 0.2 mm, particularly preferably a length of at least 0.5 mm.

The fiber content of the fiber-reinforced plastic is preferably at least 20%, particularly preferably at least 50%.

The density of the fiber-reinforced plastic is preferably maximum 2.0 g/cm³, particularly preferably maximum 1.6 g/cm³.

It is also considered to be advantageous if the fiber-reinforced plastic is impact-resistant modified.

The strain at break of the fiber-reinforced plastic is preferably at maximum 5%, particularly preferably at maximum 3% or at maximum 2%.

The stress at break of the fiber-reinforced plastic is preferably at least 200 N/mm². A stress at break range of between 200 and 300 N/mm² is considered to be advantageous.

The fiber-reinforced plastic can be formed, for example, by GRIVORY GVL-6H material or may at least also contain such a material.

Furthermore, it is considered to be advantageous if between the drive wheel and the seat belt spindle an inertia coupling is arranged which comprises coupling elements which, during an acceleration of the drive wheel, pivot outward and are directly or indirectly coupled to the seat belt spindle. An advantage of this refinement can be seen in the fact that, as a result of the pivotability of the coupling elements, after the end of the tensioning process it is possible to disengage said coupling elements again, whereby the tensioning drive may once more be separated from the seat belt spindle.

Preferably, contact surfaces of the coupling elements are formed such that they remain engaged in the tensioning rotational direction under load, and may be disengaged in the load-free state and/or in the direction of extension of the seat belt.

The coupling elements may, for example, be formed by coupling claws, coupling catches, coupling drums or coupling wedges.

The seat belt spindle preferably comprises a tubular inner wall into which the contact surfaces of the coupling elements are directly forced when pivoted outward. In this refinement, the number of parts, and thus also the weight of the seat belt retractor, are at an optimum. The contact surfaces of the coupling elements are preferably grooved.

According to a particularly preferred refinement of the seat belt retractor, it is provided that the grooved contact surfaces of the coupling elements are serrated and have alternate steep and flat edges.

Preferably, the steep and flat edges are formed such that the force is transmitted to the seat belt spindle at least substantially by the flat edges.

Preferably, the inertia coupling comprises a coupling disk which is connected to the drive wheel and is formed by an inner ring, an outer ring and at least one resilient connecting element, the coupling elements and a guide disk of the inertia coupling being inserted into the coupling disk such that, with an acceleration of the drive wheel by the gas generator, the inner ring and the guide disk are rotated relative to the outer ring due to the resilient action of the resilient connecting element(s) such that stops of the outer ring pivot the coupling elements outward.

Preferably, the resilient connecting elements are configured such that, when the tensioning force of the tensioning drive drops, the relative rotation between the inner ring and the outer ring is canceled such that the coupling elements are pivoted by further stops of the outer ring back into their initial position before the tensioning process.

In order to ensure the coupling of the seat belt spindle and the coupling elements in any angular position without jerky movements, it is considered to be advantageous if the tubular inner wall is smooth before the initial contact with the coupling elements.

The invention also relates to a method for producing a seat belt retractor. According to an embodiment of the invention, fiber-reinforced thrust elements or a thrust element chain consisting of fiber-reinforced thrust elements are/is formed by casting or injection molding.

### BRIEF DESCRIPTION OF THE DRAWINGS

The invention is described in more detail hereinafter with reference to exemplary embodiments; in this connection and by way of example:

FIGS. 1-14 show a first exemplary embodiment of a seat belt retractor according to the invention in various views,

FIGS. 15-16 show a second exemplary embodiment of a seat belt retractor according to the invention,

FIG. 17 shows an exemplary embodiment for a pair of thrust elements comprising two thrust elements which are connected to each other and consist of fiber-reinforced plastic,

FIGS. 18-20 show an exemplary embodiment in which the thrust elements form a loose thrust element chain,

FIGS. 21-23 show an exemplary embodiment in which the thrust elements form a fixedly connected thrust element chain, and

FIG. 24 shows an exemplary embodiment with a thrust element chain in which the thrust elements are connected by connecting webs.

### DETAILED DESCRIPTION

In the figures, for the sake of clarity, the same reference numerals are used for identical or comparable components.

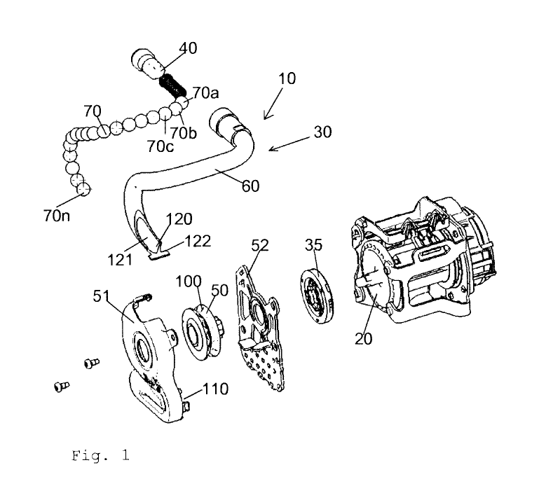

In FIG. 1, an exemplary embodiment of a seat belt retractor 10 is seen in a schematic exploded view. The seat belt retractor 10 comprises, inter alia, a seat belt spindle 20, a tensioning drive 30 and an inertia coupling 35 connecting the tensioning drive 30 and the seat belt spindle 20.

The tensioning drive 30 comprises a pyrotechnical gas generator 40, for example in the form of a micro gas generator, a drive wheel 50, a curved supply pipe 60 connecting the gas generator 40 and the drive wheel 50, and also a plurality of inertia elements or thrust elements 70.

The thrust elements 70 are, for example, spherical. All of the thrust elements preferably consist of a glass-fiber-reinforced plastic. All of the thrust elements are preferably identical to one another.

The drive wheel 50 is rotatably held between a retaining cap 51 and a retaining plate 52 and has holder shells 100 in which the thrust elements 70 engage in order to drive the drive wheel. The thrust elements 70 are, to this end, engaged tangentially in the drive wheel 50 and run tangentially past said drive wheel, engaging in the holder shells 100, in order to pass subsequently into a receptacle 110 arranged downstream.

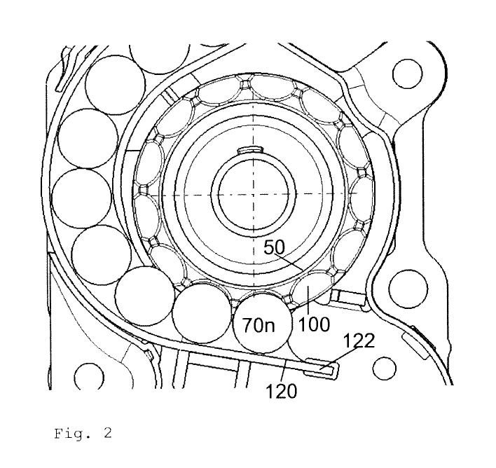

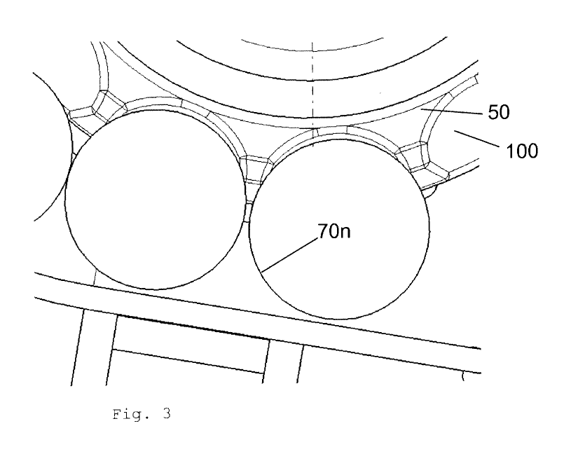

The holder shells 100 of the drive wheel 50 are preferably formed such that the thrust elements 70, when engaged in the drive wheel 50, are always spaced apart from one another and are not in contact with one another; this is, for example, shown in more detail in FIGS. 2 and 3. The force transmission preferably takes place in this case by a positive connection or at least also by a positive connection. The number of thrust elements 70 is preferably greater than the number of holder shells 100 of the drive wheel 50, and therefore the drive wheel 50 is able to rotate completely about its own axis more than simply once.

Preferably, the sealing of the supply pipe 60 takes place solely by means of the thrust elements, for example the thrust elements 70a, 70b and 70c, which—as viewed from the gas generator 40—form the first thrust elements 70 in the supply pipe 60. Sealing of the supply pipe is otherwise not required, but may nevertheless be additionally provided.

Preferably, the supply pipe 60 in the engagement region 120, in which the thrust elements 70 are engaged in the drive wheel 50, has a resilient tubular wall portion 120, by means of which the engagement behavior is optimized and jamming of the thrust elements in the drive wheel 50 is avoided. The resilient tubular wall portion 120 may, for example, have a flat end portion 121 with a T-shaped fastening element 122.

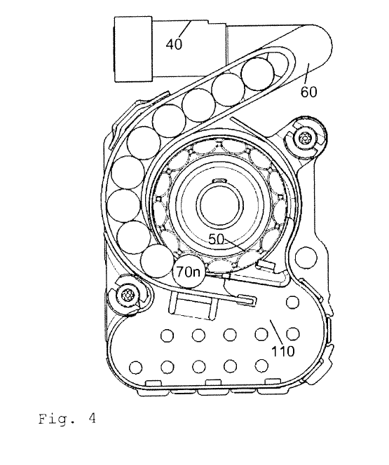

The first thrust element, i.e. the thrust element next to the drive wheel, is preferably prefixed in the delivery state of the tensioning drive 30 in a holder shell 100 of the drive wheel 50, by the drive wheel 50 itself being prefixed by means of a breakable fixing, for example in the form of a shear pin; FIG. 4 shows this in more detail.

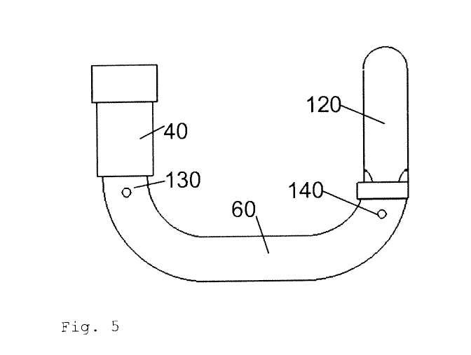

As may be seen from FIG. 5, the supply pipe 60 is preferably provided with two apertures, namely a pressure relief aperture 130 in the region of the gas generator 40 and a control aperture 140 in the central region of the supply pipe 60 between the gas generator 40 and the drive wheel 50.

The control aperture 140 may, for example, be formed by an opening in the supply pipe 60; the pressure in the supply pipe 60 is reduced by means of this opening when the last thrust element—i.e. the thrust element located closest to the gas generator 40—passes this opening. The tensioning force of the tensioning drive 30 is reduced as a result of the drop in pressure, and therefore, for example, the tensioning process may be stopped due to the counteracting seat belt extraction force. The opening is, however, preferably of sufficiently small size for the tensioning process not to be terminated solely by the drop in pressure and for all thrust elements 70 to be fired into the receptacle 110, in spite of the drop in pressure, whilst allowing a sufficiently high seat belt extraction force.

The pressure relief aperture 130 preferably prevents excess pressure of the tensioning drive 30.

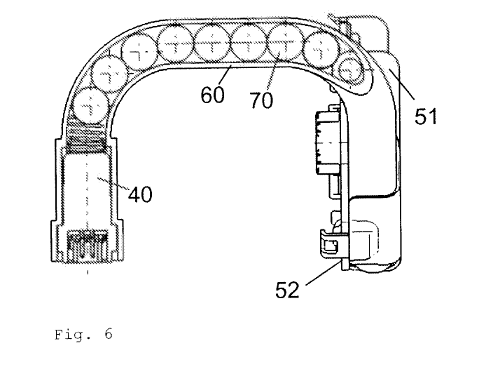

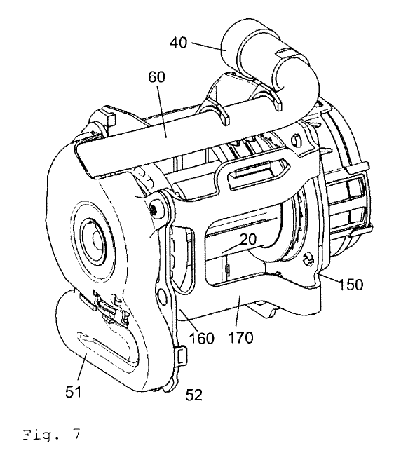

The tensioning drive 30 is shown again in FIG. 6 from above in a different view; FIG. 7 shows the seat belt retractor 10 in the mounted state. It may be seen from the two FIGS. 6 and 7 that the gas generator 40 and the drive wheel 50 are fastened to different portions 150 and 160 of a C-shaped carrier 170 of the seat belt retractor 10 and are spatially separated from one another by the seat belt spindle 20.

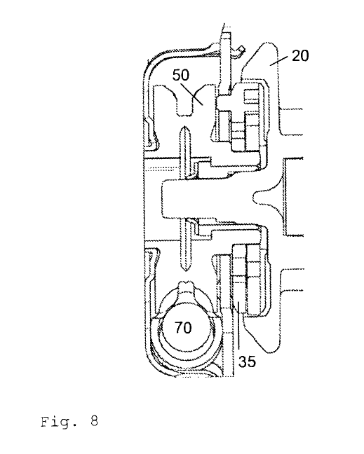

In FIG. 8, the coupling of the drive wheel 50 to the inertia coupling 35 and the coupling thereof to the seat belt spindle 20 are shown again in more detail in a section.

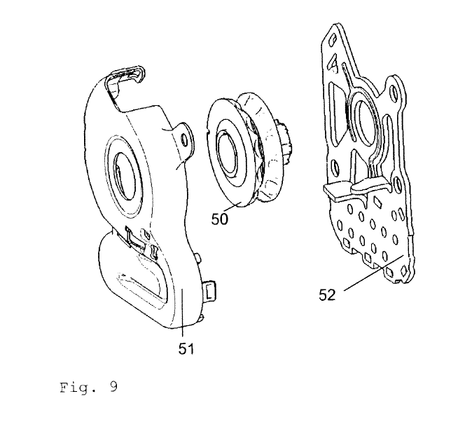

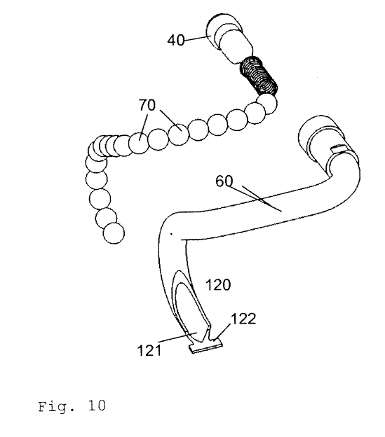

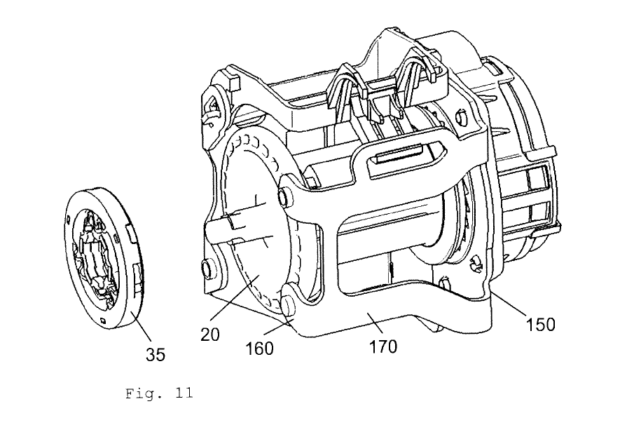

FIGS. 9, 10 and 11 show the components according to FIG. 1, again enlarged and in detail.

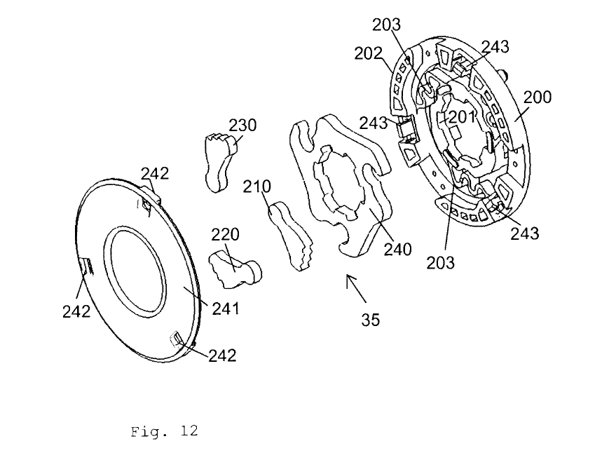

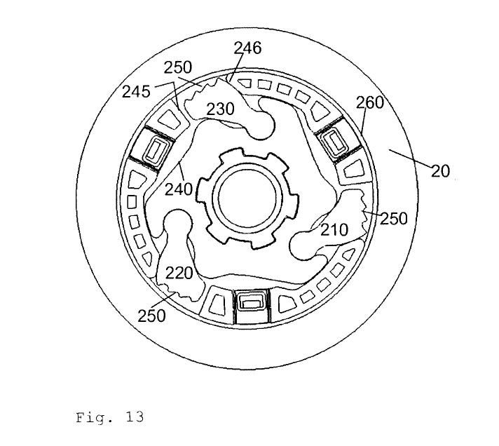

In FIGS. 12, 13 and 14, the construction of the inertia coupling 35 is shown by way of example. A coupling disk 200 may be seen, connected to the drive wheel 50 and driven thereby, and which is formed by an inner ring 201, an outer ring 202 and resilient connecting elements 203. Three coupling elements 210, 220 and 230 which may be pivoted outward and also a guide disk 240 are inserted into the coupling disk 200. In order to prevent the coupling elements 210, 220 and 230 from falling out of the guide disk 240, a cover plate 241, for example, may be present which by means of latching elements 242 and 243, for example, is latched to the coupling disk 200. FIG. 13 shows the relative position between the guide disk 240 and the outer ring 202 in the initial state.

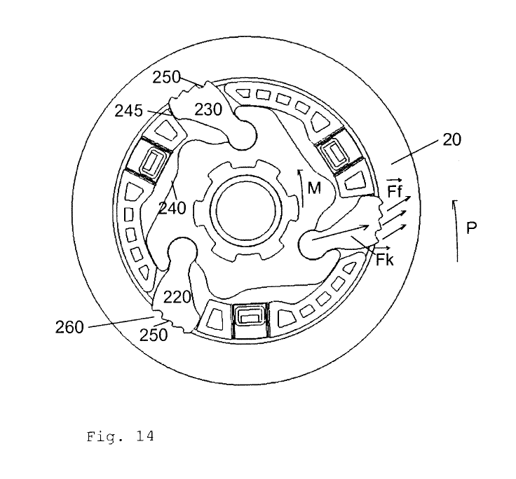

The inner ring 201 and the guide disk 240 are connected to the drive wheel fixedly in terms of rotation. If the drive wheel 50 is accelerated in the rotational direction P by the torque M of the tensioning drive 30, the inner ring 201 is rotated relative to the outer ring 202 due to the resilient action of the resilient connecting elements 230 as a result of inertia such that stops 245 of the outer ring 202 pivot the coupling elements 220, 230 and 240 outward (see FIG. 14) and said coupling elements with their grooved contact surfaces 250 are driven into the tubular inner wall 260 of the seat belt spindle 20 which is preferably smooth, i.e. formed without grooves or the like, whereby the coupling elements are connected to the seat belt spindle 20 and the coupling is engaged. The force of the coupling elements is denoted by the force vector \vec{F}k. The force transmission by the flat edges is denoted by the force vector \vec{F}f.

If the tensioning force of the tensioning drive 30 is reduced, for example because the gas generator 40 is used up, and may no longer provide sufficient drive pressure, or after completing the tensioning process the seat belt spindle is rotated in the direction of extension of the seat belt, the relative rotation between the inner ring 201 and the outer ring 202 is again cancelled due to the resilient action of the resilient connecting elements 203, and therefore the coupling elements 210, 220 and 230 are pivoted back by further stops 246 of the outer ring 202 into their initial position (see FIG. 13) before the tensioning process, and are once more separated from the seat belt spindle 20, and therefore the drive wheel 50 may not be rotated in the direction of extension of the seat belt.

The driving of the coupling elements into the inner wall 260 and the pivoting back of the coupling elements for the purpose of disengagement is made much simpler by the serrated shape of the contact surfaces 250, which have alternate steep and flat edges. As may be seen from FIG. 14, the serrated shape is selected such that the force transmission relative to the inner wall 260 is carried out by the flat edges. The flat edges, during the coupled state, are at a shallower angle relative to the inner wall 260 than the steep edges. It may be seen that the force vector of the flat edges \vec{F}f relative to the force vector \vec{F}k of the coupling elements is rotated by the alignment of the flat edges, and namely by an angle of between preferably 0 and 45 degrees and in the direction of the torque M and/or in the tensioning rotational direction P.

Preferably, a seat belt force limiting mechanism is not provided in the force transmission path between the tensioning drive 30 and the seat belt spindle 20, i.e. neither between the drive wheel 50 and the inertia coupling 35 nor between the inertia coupling 35 and the seat belt spindle 20. The seat belt force is preferably limited only in the direction of extension of the seat belt, and namely by a torsion bar, not shown further, which with one end is rigidly connected to the seat belt spindle and with its other end to a locking mechanism of the seat belt retractor 10.

The seat belt retractor is preferably fixedly fastened to the vehicle frame (fixed to the frame). Each tensioning drive, for example for lap belt tensioning and/or shoulder belt tensioning, preferably has its own gas generator.

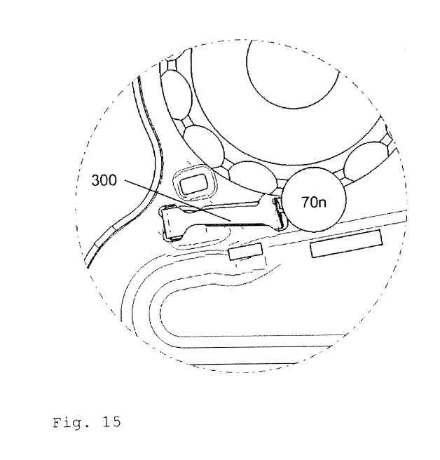

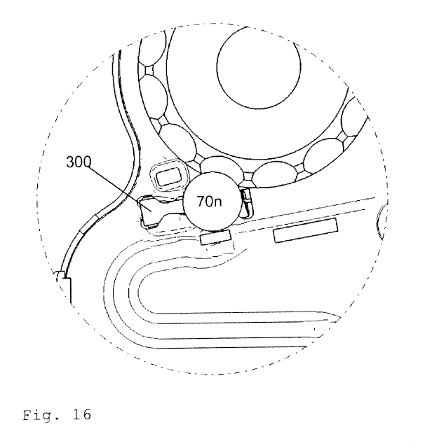

In FIGS. 15 and 16 a further exemplary embodiment of a seat belt retractor 10 is shown. In this exemplary embodiment, a backstop device in the form of a pivotable spring element 300 is present, which may be passed in only one direction by the thrust elements running past the drive wheel 50, namely in the direction of the receptacle 110. The spring element 300 thus prevents, for example, the last thrust element 70n from being able to be moved back again toward the drive wheel 50 after completing the tensioning process.

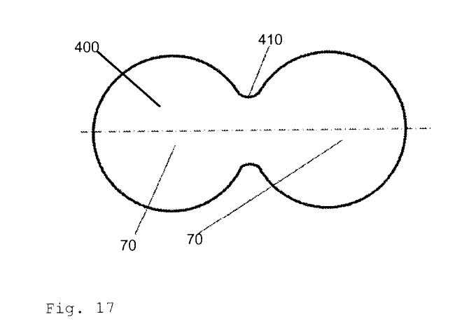

FIG. 17 illustrates an exemplary embodiment of a pair of thrust elements 400 consisting of two thrust elements 70 which are connected to each other and each consist of fiber-reinforced plastic. The connecting region 410 between the two thrust elements 70 preferably also consists of fiber-reinforced plastic.

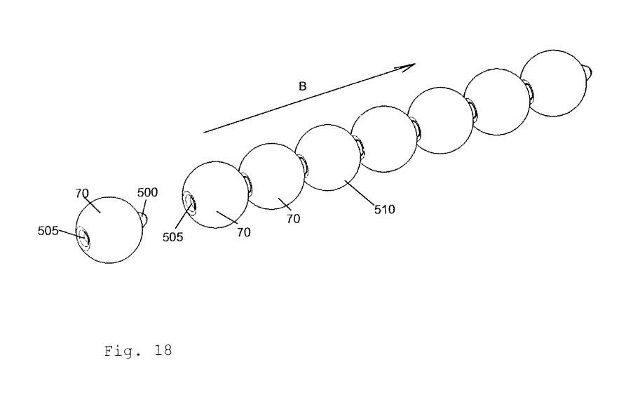

FIG. 18 shows an exemplary embodiment in which the thrust elements 70 are plugged loosely one in another. For this purpose, the thrust elements 70 each have a plug-in section 500 in the form of a plug-in lug which is plugged into a recess 505 in the form of a blind hole in the respectively adjacent thrust element 70. By the thrust elements 70 being plugged one into another, a loose thrust element chain 510 is formed, the longitudinal direction of which corresponds to the direction of movement B of the thrust elements 70 in the supply pipe of the seat belt retractor.

By means of the formation of the thrust element chain 510, guidance of the thrust elements 70 in the supply pipe is achieved, specifically in such a manner that the alignment of the thrust elements in the thrust element chain 510 and the alignment of the thrust elements in the supply pipe remain the same—with respect to the particular direction of movement B during the movement through the supply pipe.

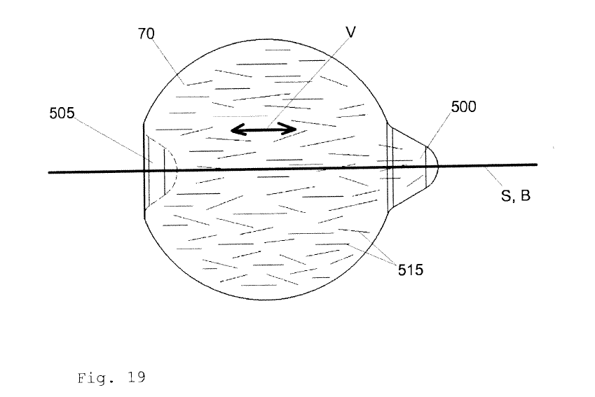

FIG. 19 shows one of the thrust elements 70 according to FIG. 18 in cross section. It may be seen that the thrust element 70 consists of a fibrous material. The fibers 515 in the fiber-reinforced thrust element 70 are not oriented randomly but rather have a preferred orientation. The preferred orientation arises by the fact that at least half of the fibers 515 are at an angle of less than 45 degrees to a mean fiber direction—called the main fiber direction here—which is denoted by the reference symbol V in FIG. 19. The preferred orientation of the fibers therefore defines the main fiber direction V.

It may also be seen in FIG. 19 that the fiber-reinforced thrust element 70 is rotationally symmetrical and has an axis of symmetry S. The axis of symmetry S is preferably identical to the main fiber direction V; at least, the angle between the axis of symmetry S and the main fiber direction V should preferably be smaller than 10 degrees. By means of this fiber alignment, a particularly high degree of stability of the thrust elements 70 in the direction of movement B is achieved in an advantageous manner, and therefore the thrust elements can withstand the high mechanical loadings precisely in the acceleration phase.

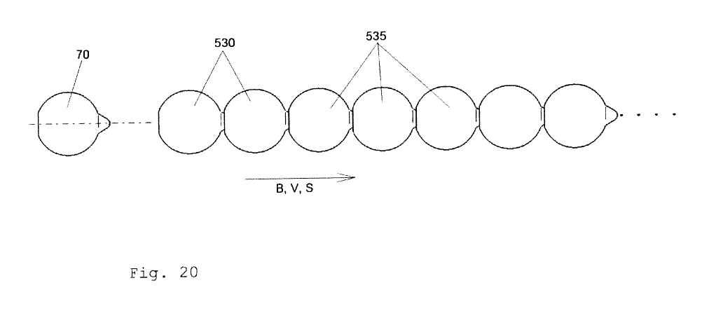

In the exemplary embodiment according to FIGS. 18 and 19, the thrust elements 70 are loosely connected to one another by being plugged one in another. As an alternative, groups of two or more thrust elements can also be fixedly connected to one another and can form, for example, twin or triple groups. Such twin and triple groups are shown by way of example in FIG. 20 and are denoted by the reference numerals 530 and 535.

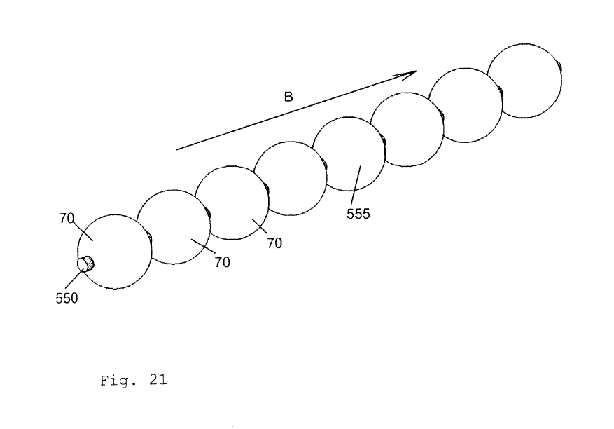

FIG. 21 shows an exemplary embodiment in which the thrust elements 70 are connected to one another by a flexible, strand-shaped link 550. A mechanically flexible thrust element chain 555 is formed by the strand-shaped link 550.

The flexible, strand-shaped link 550 may be, for example, a cable or a wire. The flexible, strand-shaped link 550 preferably consists of plastic and/or metal, for example steel.

The thrust element chain 555 according to FIG. 21 is preferably produced within the scope of a casting process, in particular injection molding process, in which the strand-shaped link 550 is cast into the fibrous material of the thrust elements.

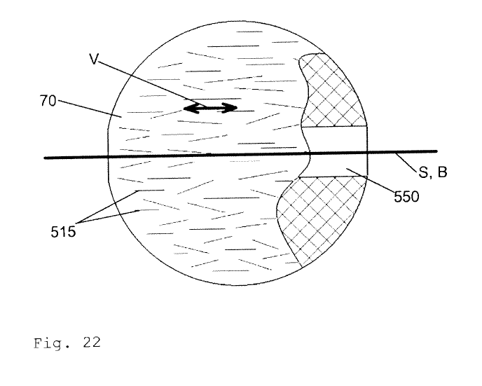

FIG. 22 shows one of the thrust elements 70 of the thrust element chain 555 according to FIG. 21 in cross section. It may be seen that the strand-shaped link 550 is embedded, preferably cast, into the fibrous material of the thrust elements.

In addition, it may be seen that the main fiber direction V of the fibers 515 is identical to the longitudinal direction of the axis of symmetry S, the longitudinal direction of the strand-shaped link 550 or the longitudinal direction of the thrust element chain 555 and to the direction of movement B. Such directional identity is not absolutely necessary, but it is considered to be advantageous if the angle between the main fiber direction V and the longitudinal direction of the strand-shaped link 550 or the longitudinal direction of the thrust element chain 555 and the direction of movement B is at least smaller than 10 degrees.

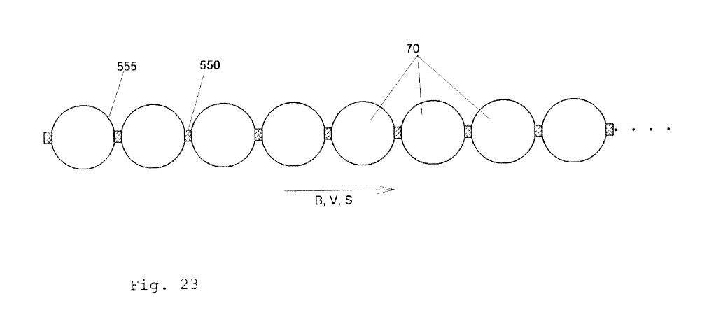

FIG. 23 shows the thrust element chain 555 according to FIG. 21 in a view from the side. It may also be seen here that the strand-shaped link 550 is embedded in the fibrous material of the thrust elements and extends through a plurality of thrust elements.

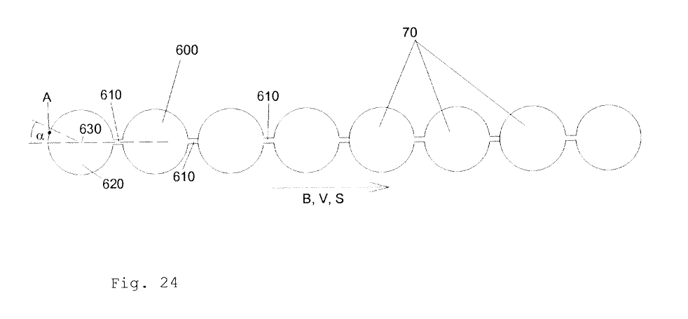

FIG. 24 shows an exemplary embodiment of a thrust element chain 600 in which the thrust elements 70 of the thrust element chain are connected to one another by webs (connecting webs) 610. The webs 610 are preferably already formed during the injection molding of the thrust elements 70 by the thrust element chain 600 being injected or cast in a single piece including the webs 610. The injection point A (or the injection points) of the injection molding material 620 containing the fibers is preferably at least also located at or in the region of the end of the thrust element chain 600.

A preferred injection angle α for the injection direction of the injection molding material 620 may be seen in FIG. 24. The injection angle α is preferably between 0 degrees and 30 degrees with respect to the longitudinal axis of the thrust element chain 600 and with respect to the subsequent direction of movement of the thrust elements 70. The angle shown in FIG. 24 relates by way of example to the center point 630 of the thrust element 70 at which the injection is taking place.

Preferably, the injection is carried out at or in the region of the end of the thrust element chain 600; this has the advantage that the injection molding material is forced through the web regions of the injection mold, thus resulting in a particularly advantageous manner in an alignment of the longitudinal direction of the fibers of the injection molding material in the longitudinal direction of the chain and therefore along the subsequent direction of movement of the thrust elements.

The webs 610 between the thrust elements 70 may be elastic (by means of an appropriate choice of material) in order to enable bending of the thrust element chain 600 in regions of curvature of the supply pipe. As an alternative, the webs 610 may also be rigid or of such stiffness that they prevent bending of the thrust element chain 600; in this case, the webs 610 will break when they are introduced under pressure into regions of curvature of the supply pipe during the assembly of the seat belt retractor, or are pressed through the supply pipe during the subsequent tensioning operation.

In order to permit casting or injection molding of the thrust chain and subsequent breaking of the webs, a web diameter of between 0.1 mm and 10 mm is considered to be advantageous. The maximum web diameter is produced from the requirement that the webs may break when passing through curvatures in the supply pipe; the minimum web diameter is dependent on the viscosity of the thrust element material to be cast or to be injected. The viscosity of the thrust element material is determined by the basic material, i.e., for example, by the type of plastic, and the concentration of the fibers: the greater the concentration of fibers, the more viscous is the thrust element material to be cast or injected, and the size of the web diameter should be selected, with regard to the casting or injection molding process, in accordance with the degree of viscosity of the thrust element material in order to enable the thrust element material to be able to pass the web regions in the casting mold during the casting or injection molding. If the thrust element material is too viscous and the web region is too small, the casting/injection molding is made more difficult or even impossible. In the case of many materials, in particular in the case of plastics, such as polyamides, and/or a fiber concentration of between 40% and 70% (60%±5% are considered preferable), a web diameter within the range of between 1 mm and 3 mm is particularly advantageous: such a diameter permits casting/injection molding, and the webs are nevertheless thin enough to be able to break as they pass through curvatures in the supply pipe.

The thrust element chain 600 can be introduced into the supply pipe, for example, by a filling pipe which is placed onto the supply pipe and permits the thrust element chain 600 to be introduced under a sufficiently high pressure such that a breaking of the webs 610 may optionally occur.

The priority application, German Patent Application No. DE 10 2010 033 184.8; filed on Aug. 3, 2010 is incorporated by reference herein.

### LIST OF DESIGNATIONS

10 Seat belt retractor
20 Seat belt spindle
30 Tensioning drive
35 Inertia coupling
40 Gas generator
50 Drive wheel
51 Retaining cap
52 Retaining plate
60 Supply pipe
70 Thrust element
100 Holder shells
110 Receptacle
120 Tubular wall portion
121 End portion
122 T-shaped fastening element
130 Pressure relief aperture
140 Control aperture
150 Portion
160 Portion
170 U-shaped carrier
200 Coupling disk
201 Inner ring
202 Outer ring
203 Resilient connecting elements
210 Coupling claw
220 Coupling claw
230 Coupling claw
240 Guide disk
241 Cover plate
242 Latching element
243 Latching element
245 Stops
246 Further stops
250 Contact surface
260 Inner wall
300 Spring element
400 Pair of thrust elements
410 Connecting region
500 Plug-in section
505 Recess
510 Loose thrust element chain
515 Fiber
530 Twin group
535 Triple group
550 Strand-shaped link
555 Mechanically flexible thrust element chain
600 Thrust element chain
610 Web
620 Injection molding material
630 Center point
A Injection point
α Injection angle
B Direction of movement
\vec{F}k Force vector
\vec{F}f Force vector
M Torque
P Tensioning rotational direction
V Main fiber direction
S Axis of symmetry

1. A seat belt refractor for a safety belt comprising a seat belt spindle for winding up and unwinding the safety belt and a tensioning drive, which comprises:
a gas generator,
a drive wheel and
a supply pipe which connects the gas generator and the drive wheel,
a plurality of thrust elements being present in the supply pipe which, after triggering the gas generator, are accelerated and indirectly or directly drive the drive wheel for winding up the safety belt,
wherein at least one of the thrust elements is a fiber-reinforced thrust element.

2. The seat belt retractor as claimed in claim 1, wherein the fibers in the fiber-reinforced thrust element have a preferred orientation.

3. The seat belt retractor as claimed in claim 1, wherein the fiber-reinforced thrust element is guided in the supply pipe in such a manner that the alignment of said thrust element remains the same—with respect to the particular direction of movement—during the movement through the supply pipe.

4. The seat belt retractor as claimed in claim 1, wherein
at least half of the fibers of the fiber-reinforced thrust element are at an angle of less than 45 degrees to a mean main fiber direction (V), and
the mean main fiber direction (V) forms the preferred orientation of the fibers in the fiber-reinforced thrust element.

5. The seat belt retractor as claimed in claim 1, wherein the fiber-reinforced thrust element is guided in the supply pipe in such a manner that the angle between the main fiber direction and the particular direction of movement (B) is always smaller than 45 degrees.

6. The seat belt retractor as claimed in claim 1, wherein the fiber-reinforced thrust element has an axis of symmetry (S), and the angle between the axis of symmetry (S) and the main fiber direction (V) is smaller than 10 degrees.

7. The seat belt retractor as claimed in claim 1, wherein the fiber-reinforced thrust element is guided in the supply pipe in such a manner that the angle between the axis of symmetry (S) and the particular direction of movement (B) during the movement through the supply pipe is smaller than 45 degrees.

8. The seat belt retractor as claimed claim 1, wherein at least two consecutive thrust elements in the supply pipe are partially plugged one into the other.

9. The seat belt retractor as claimed in claim 1, wherein at least one thrust element in the supply pipe has at least one plug-in section which is plugged into a recess in an adjacent thrust element in the supply pipe.

10. The seat belt retractor as claimed in claim 1, wherein at least two of the thrust elements are connected to one another forming a thrust element chain or a pair of thrust elements.

11. The seat belt refractor as claimed in claim 10, wherein the at least two thrust elements are connected to one another by a flexible, strand-shaped link, in particular a cable or a wire.

12. The seat belt refractor as claimed in claim 11, wherein the strand-shaped link is embedded in the fiber-reinforced material of at least two thrust elements, in particular cast with the fiber-reinforced material of at least two thrust elements.

13. The seat belt retractor as claimed in claim 1, wherein at least one of the thrust elements contains fiber-reinforced, for example glass-fiber-reinforced, plastic or consists of fiber-reinforced, for example glass-fiber-reinforced, plastic.

14. The seat belt refractor as claimed in claim 13, wherein the fiber-reinforced plastic contains at least one of the following plastics: a polyamide, a heat-stabilized, partially crystalline polyamide and/or polyphthalamide.

15. A method for producing a seat belt retractor for a safety belt comprising a seat belt spindle for winding up and unwinding the safety belt and a tensioning drive, which comprises a gas generator, a drive wheel and a supply pipe which connects the gas generator and the drive wheel, a plurality of thrust elements being present in the supply pipe which, after triggering the gas generator, are accelerated and indirectly or directly drive the drive wheel for winding up the safety belt, at least one of the thrust elements being a fiber-reinforced thrust element,
wherein fiber-reinforced thrust elements or a thrust element chain consisting of fiber-reinforced thrust elements are/is formed by casting or injection molding.
